(19) United States
(12) Patent Application Publication
(10) Pub. No.: US 2023/0095858 A1
(43) Pub. Date: Mar. 30, 2023

(54) PURPOSE OF PURCHASE ANALYSIS TO BOOST RECOMMENDATION CONVERSION RATES

(71) Applicant: NCR Corporation, Atlanta, GA (US)

(72) Inventors: Itamar David Laserson, Givat Shmuel (IL); Shay Marom, Kiryat Tiv'on (IL)

(21) Appl. No.: 17/489,943

(22) Filed: Sep. 30, 2021

(51) Int. Cl. G06Q 30/02; G06Q 30/06; G06F 9/54; G06N 20/00

(52) U.S. Cl. CPC G06Q 30/0203; G06Q 30/0631; G06F 9/54; G06N 20/00

(57) ABSTRACT

An ecommerce application (app) or a transaction interface of a transaction terminal are enhanced to call a Purpose of Purchase (POP) service during a user session with the app or the terminal. The POP service integrates a question posed to the user regarding the user's POP for the session. A machine-learning model is trained on customer answers, transaction data, history data, and/or loyalty data to predict a customer's POP profile classification. When another customer is engaged in a session and fails to provide an answer, the model predicts a POP profile for the customer and the session. When the customer provides an answer, the appropriate POP profile that corresponds to the answer is assigned. During the session, the POP service provides the assigned or predicted POP profile to a recommendation service to use as a factor in making a product recommendation to the user during the session.

### BACKGROUND

Most user-based ecommerce applications (apps) are already interfaced to product recommendation engines (services) to produce and present recommendations to user. However, using the recommended products effectively within the ecommerce apps to achieve an optimal conversion rate (purchase rate of recommended products) is challenging.

Furthermore, many retailers provide checkout terminal interfaces that use recommendation engines in efforts to recommend additional products in the store as the customer checkouts at the terminal.

Current product recommendation engines are missing out on an important aspect associated with successful conversions. This aspect is a customers “Purpose of Purchase (POP).” Current solutions rely on the “lowest common denominator” of customers that are shopping to influence recommendations without analyzing what actually brought the shoppers to the store/website to make a purchase in the first place. Often this lowest common denominator is associated with a given customers transaction history relative to other customers with similar transaction histories that were successfully converted during a purchase.

Personalization is one of the fastest growing areas in retail. Achieving high conversion rates on product recommendations provided through recommendation engines are critical for retailers who wish to sustain the growing competition faced in the e-commerce and in-store industry segments.

Unfortunately, some existing recommendation engines do not even attempt to factor in a customer's POP, which intuitively would be a most significant factor in the customer's reason for visiting an e-commerce site or visiting a store in person to make a purchase. Some in the industry are under a false impression that resolving a customer's POP cannot be achieved while others in the industry generically attempt to guess at the customer's POP, which can be more detrimental to a successful conversion than ignoring the POP altogether because POPs can vary widely.

Overall, existing recommendation engines are suboptimal because they fail to account for or they overly generalize their customers' POPs, resulting in lost opportunities for the retailers.

### SUMMARY

In various embodiments, methods and a system for assigning customers to Purposes of Purchase (POPs) and to boost a recommendation engine's conversion rate on recommendations made to the customers are presented.

According to an aspect, a method for providing a customer's POP as a factor in a recommendation provided by a recommendation engine/service, is presented. A Purpose of Purchase (POP) question is integrated into a transaction session of a customer. A POP profile is assigned to the customer of the transaction session when an answer is provided by the customer to the POP question during the transaction session. The POP profile is predicted for the customer when the customer fails to provide the answer to the POP question based on transaction data for the transaction session and customer data for the customer. The POP profile for the customer is provided to a recommendation service for use as a factor in providing the customer with a recommendation during the transaction session.

### BRIEF DESCRIPTION OF THE DRAWINGS

FIG. 1 is a diagram of a system for assigning customers to POPs and to boost a recommendation engine's conversion rate on recommendations made to the customers, according to an example embodiment.

FIG. 2 is a diagram of a method for providing a customer's POP as a factor to a recommendation provided by a recommendation engine, according to an example embodiment.

FIG. 3 is a diagram of another method for providing a customer's POP as a factor to a recommendation provided by a recommendation engine, according to an example embodiment.

### DETAILED DESCRIPTION

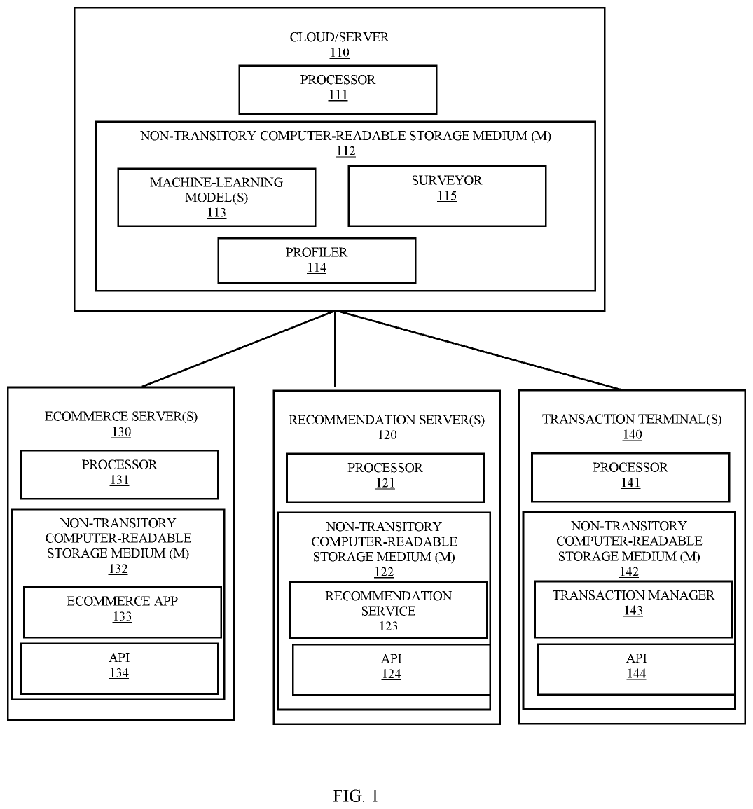

FIG. 1 is a diagram of a system 100 for assigning customers to POPs and to boost a recommendation engine's conversion rate on recommendations made to the customers, according to an example embodiment. It is to be noted that the components are shown schematically in greatly simplified form, with only those components relevant to understanding of the embodiments being illustrated.

Furthermore, the various components (that are identified in FIG. 1) are illustrated and the arrangement of the components is presented for purposes of illustration only. It is to be noted that other arrangements with more or less components are possible without departing from the teachings of providing customer POPs to recommendation engines as a factor in the product recommendations provided to the customers as presented herein and below.

As will be discussed in the various embodiments that follow, the teachings provide techniques by which customers' POPs are collected directly from the customers following purchases made by the customers. A small survey question is integrated into e-commerce applications or in-store transaction manager interfaces. The POPs are then associated with customer transaction histories and other data surrounding the purchases (such as customer loyalty data) and used to train a machine-learning model (MLM) for purposes of predicting a subsequent customer's POP at the time a customer is engaged with an e-commerce application or performing a transaction in-store at a transaction terminal. The trained MLM classifies a given customer in a given situation/context (e-commerce session or in-store purchase) into one of the known POPs (a POP profile). When the customer answers the survey question, the MLM uses the answer to assign the customer to a POP profile. When the customer fails to answer the survey question, the MLM uses the customer's historical data to predict the most likely POP profile for the customer. A customer's assigned POP profile is provided in real-time to the recommendation engine associated with the e-commerce site or associated with the in-store transaction terminal to use as a factor of import in making a product recommendation to the customer. Following the customer transaction if a conversion was made or was not made on the recommended product, the assigned customer POP profile, an indication as to whether the recommended product was or was not purchased (was or was not converted), and the original customer purchase transaction details are saved for subsequent re-training of the MLM to improve the MLM's accuracy in assigning POP profiled to subsequent customers engaged with an e-commerce site or engaged in a transaction with an in-store terminal.

System 100 comprises a cloud/server 110, a plurality of recommendation servers 120, a plurality of ecommerce servers 130, and a plurality of in-store transaction terminals 140.

Cloud/Server 110 comprises at least one processor 111 and a non-transitory computer-readable storage medium 112. Medium 112 comprises executable instructions for one or more machine-learning models (algorithms) 113, a POP profiler 114, and a surveyor 115. The executable instructions when executed by processor 111 from the medium 112 cause processor 111 to perform operations discussed herein and below with model(s) 113, profiler 114, and surveyor 115.

Each recommendation server 120 comprises a processor 121 and a non-transitory computer-readable storage medium 122. Medium 122 comprises executable instructions for a recommendation service (engine) 123 and an Application Programming Interface (API) 124. The executable instructions when executed by processor 121 from medium 122 cause processor 121 to perform operations discussed herein and below with respect to engine 123 and API 124.

Each ecommerce server 130 comprises a processor 131 and a non-transitory computer-readable storage medium 132. Medium 132 comprises executable instructions for an ecommerce app 133 and an API 134. The executable instructions when executed by processor 131 from medium 132 cause processor 131 to perform operations discussed herein and below with respect to ecommerce app 133 and API 134.

Each transaction terminal 140 comprises a processor 141 and a non-transitory computer-readable storage medium 142. Medium 142 comprises executable instructions for a transaction manager 143 and an API 144. The executable instructions when executed by processor 141 from medium 142 cause processor 141 to perform operations discussed herein and below with respect to transaction manager 143 and API 144.

Initially, workflows associated with ecommerce app 133 and transaction interfaces of transaction manager 144 are modified to make a call via API 134 and API 144, respectively to receive and present customers with a question regarding the POP for an item/product purchased by each customer via the ecommerce app 133 and/or the transaction manager 143. The surveyor 115 asks one or a few simple questions of the customers to determine the POPs based on the transaction details for the customers' purchases. For example, depending upon the item code purchased by a customer, the retailer identifier, the store identifier, purchase location, etc. a multiple-choice question is asked, “did you purchase X today because: A) weekly purchase was time to purchase; B) party or event and was in need of X; C) stocking up on X; D) impulse buy; E) gift for someone else; F) vehicle needed fuel (when X is fuel); G) based on an advertisement online, on tv, online; H) recommended by someone; etc. A second question may simply be an input field that says in as few words as possible what brought you to the e-commerce site or the store today.

The options to present in the multiple-choice question can be contextually selected by surveyor 115 based on the retailer associated with the e-commerce app 133 or terminal 140, an item code associated with one or more items that were purchased by the customer, a location of the store, a time of day, a day of week, a calendar date, etc.

System 100 uses surveyor 115 to collect a predefined number of transactions with answers provided back by the customers through ecommerce app 133 and transaction manager 143. The answers, corresponding transaction details (including transaction location (online or instore and if instore specific geographical location and item information for item(s) purchased), and customer transaction histories for the customers, customer loyalty data for the customers. MLM 113 is then trained on the transaction details, transaction histories, and loyalty data to produce the corresponding answers as output associated with a POP profile.

In an embodiment, before the MLM 113 is trained, the answers are mapped to a predefined set of POP profiles, such that there is not a direct 1-1 mapping between each answer and each POP profile. The MLM 113 is then trained to produce the POP profile based on the answers.

When a customer fails to provide an answer to a survey from surveyor 115, MLM 113 is trained to predict a POP profile based on the transaction details, customer transaction history, and customer loyalty data. So, when a customer provides an answer, MLM 113 uses or maps the answer to a POP profile and when the customer does not provide an answer, MLM 113 predicts a POP profile based on the information provided for the transaction.

The POP profiles may further be mapped to simple selections associated with the survey choices provided to customers to answer following transactions and fed back to the MLM 113 during training to correct predicted POP profiles of the MLM 113.

Once MLM 113 is trained to a desired level of accuracy in predicting POPs of customers, a customer that answers the survey question by surveyor 115 is assigned the corresponding POP profile by profiler 114. A customer that provides no answer to the survey question results in profiler 114 providing the customer transaction history, loyalty data, and transaction details to MLM 113 as input and receiving as output a predicted POP profile classification for the customer and the transaction.

Profiler 114 provides the POP profile of the customer (ether provided by the customer or predicted by MLM 113) to recommendation service 123 through API 124. Recommendation service 134 uses the customer-assigned POP profile as a factor in making a product recommendation to the customer via ecommerce app 133 of via transaction interface of transaction manager 143. A result of the recommendation (converted/purchased or not purchased) is provided back to profiler 114 to re-train MLM 113 for purposes of achieving a higher conversion rate based on an assigned POP profile to a given customer in a given transaction.

Existing recommendation engines do not consider as a factor in product recommendation, the reason the customer is in fact making a purchase with a retailer on a retailer e-commerce site or at a retailer store. This reason is probably the most significant reason the retailer sold an item and yet it is not utilized in conventional recommendation services. System 100 corrects that deficiency by obtaining actual POPs of customers and training a model 113 to predict a POP profile for customers who do not identify their POPs. The assigned POP profile is then provided to an enhanced recommendation service 123 that uses the POP profile classification of a customer as an additional and a substantial factor in product recommendations to the customer. Conversions or non-conversions are noted, and the corresponding transaction information and customer information used to retrain the MLM 113 to achieve more accurate POP profile predictions and increased conversion rates by the recommendation service 123.

In an embodiment, the recommendation service 123 and API 124 may be subsumed into either cloud/server 110 and/or ecommerce server 130.

In an embodiment, MLM 113, surveyor 115, and profiler 114 are subsumed into either ecommerce server 130 and/or recommendation server 120.

In an embodiment, transaction terminals 140 can be Point-Of-Sale (POS) terminals operated by a cashier that checks a customer out at a store or a Self-Service Terminal (SST) that a customer operates to perform a self-checkout. Any SST can be an Automated Teller Machine (ATM), a Self-Checkout (SCO) terminal, and/or a kiosk.

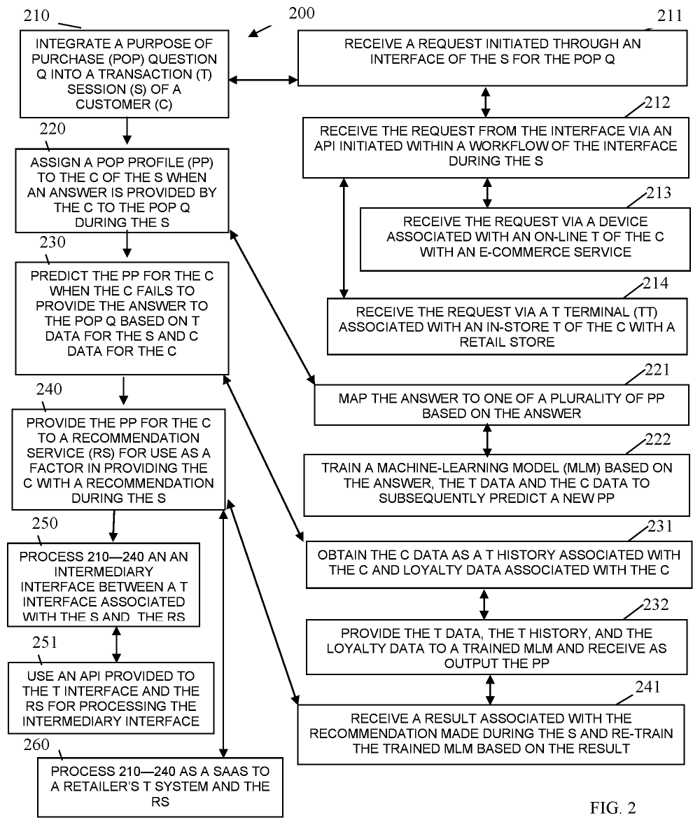

The above-referenced embodiments and other embodiments are now discussed with reference to FIGS. 2.

FIG. 2 is a diagram of a method 200 for providing a customer's POP as a factor to a recommendation provided by a recommendation engine, according to an example embodiment. The software module(s) that implements the method 200 is referred to as a “POP classifier.” The POP classifier is implemented as executable instructions programmed and residing within memory and/or a non-transitory computer-readable (processor-readable) storage medium and executed by one or more processors of one or more devices. The processor(s) of the device(s) that executes the POP classifier are specifically configured and programmed to process the POP classifier. The POP classifier has access to one or more network connections during its processing. The connections can be wired, wireless, or a combination of wired and wireless.

In an embodiment, the device that executes the POP classifier is cloud 110. In an embodiment, the device that executes POP classifier is server 110.

In an embodiment, the POP classifier is all of, or some combination of model(s) 113, profiler 114, surveyor 115, API 124, and/or optimizer API 144.

At 210, POP classifier integrates a POP question into a transaction session of a customer.

In an embodiment, at 211, the POP classifier receives a request initiated through an interface of the transaction session for the POP question.

In an embodiment of 211 and at 212, the POP classifier receives the request from the interface via an API initiated within a workflow of the interface during the transaction session.

In an embodiment of 212 and at 213, the POP classifier receives the request via a device associated with an on-line transaction of the customer with an e-commerce service.

In an embodiment of 212 and at 214, the POP classifier receives the request via a transaction terminal associated with an in-store transaction of the customer with a retail store.

At 220, the POP classifier assigns a POP profile to the customer of the transaction session when an answer is provided by the customer to the POP question during the transaction session.

In an embodiment, at 221, the POP classifier maps the answer to one of a plurality of POP profiles based on the answer.

In an embodiment of 221 and at 222, the POP classifier trains a machine-learning model 113 based on the answer, the transaction data for the transaction session, and the customer data for the customer to subsequently predict a new POP profile without an answer being provided by a subsequent customer during a subsequent transaction session.

At 230, the POP classifier predicts the POP profile for the customer when the customer fails to provide the answer to the POP question based on transaction data for the transaction session and customer data for the customer.

In an embodiment, at 231, the POP classifier obtains the customer data as transaction history data associated with the customer and loyalty data associated with the customer.

In an embodiment of 231 and at 232, the POP classifier provides the transaction data, the transaction history, and the loyalty data to a trained machine-learning model 113 (MLM 113) and receives as output from the MLM 113 the POP profile.

At 240, the POP classifier provides the POP profile for the customer to a recommendation service/engine 123 for use as a factor in providing the customer with a product recommendation during the transaction session.

In an embodiment, at 250, the POP classifier is processed as an intermediary between a transaction interface associated with the transaction session and the recommendation service/engine 123.

In an embodiment of 250 and at 251, the POP classifier uses or processes an API provided to the transaction interface and the recommendation service/engine 123 for processing the intermediary interface.

In an embodiment, at 260, the POP classifier is provided as and processed as a Software-as-a-Service (SaaS) to a retailer's transaction system (ecommerce server 130 and/or transaction terminals 140) and the recommendation service/engine 123.

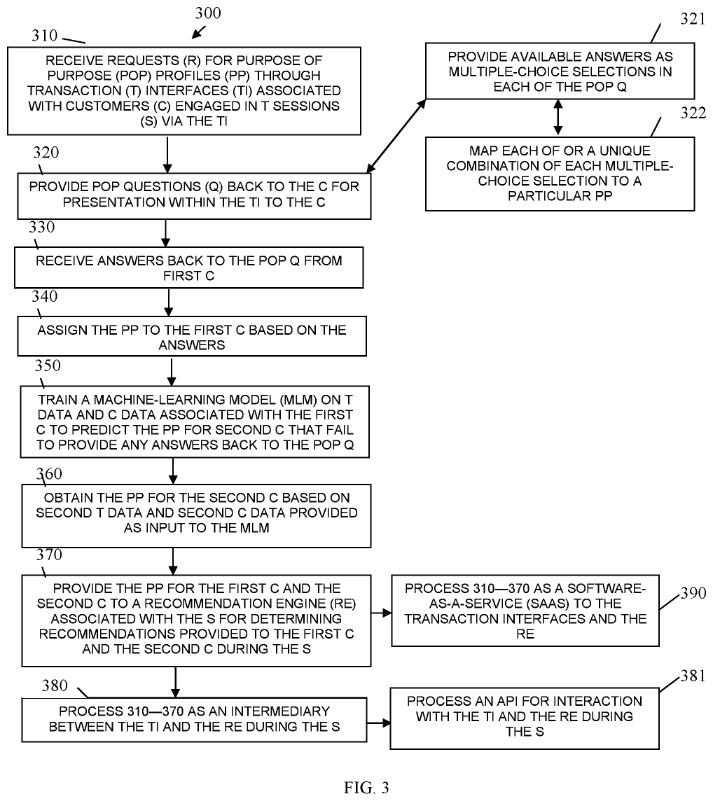

FIG. 3 is a diagram of another method 300 for providing a customer's POP as a factor to a recommendation provided by a recommendation engine, according to an example embodiment. The software module(s) that implements the method 300 is referred to as a “real-time recommendation service POP profile predictor.” The real-time recommendation service POP profile predictor is implemented as executable instructions programmed and residing within memory and/or a non-transitory computer-readable (processor-readable) storage medium and executed by one or more processors of one or more devices. The processor(s) of the device(s) that executes the real-time recommendation service POP profile predictor are specifically configured and programmed to process the real-time recommendation service POP profile predictor. The real-time recommendation service POP profile predictor has access to one or more network connections during its processing. The network connections can be wired, wireless, or a combination of wired and wireless.

In an embodiment, the device that executes the real-time recommendation service POP profile predictor is cloud 110. In an embodiment, the device that executes the real-time recommendation service POP profile predictor is server 110.

In an embodiment, the real-time recommendation service POP profile predictor is all of, or some combination of model(s) 113, profiler 114, surveyor 115, API 124, optimizer API 144, and/or method 200.

The real-time recommendation service POP profile predictor presents another, and in some ways, enhanced processing perspective from that which was discussed above for method 200.

At 310, the real-time recommendation service POP profile predictor receives requests for POP profiles through transaction interfaces (133 and/or 143) associated with customers engaged in transaction sessions via the transaction interfaces.

At 320, the real-time recommendation service POP profile predictor provides POP questions back to the customers for presentation within the transaction interfaces to the customers.

In an embodiment, at 321, the real-time recommendation service POP profile predictor provides available answers as multiple-choice selections in each of the POP questions.

In an embodiment of 321 and at 322, the real-time recommendation service POP profile predictor maps each of or a unique combination of each multiple-choice selection to a particular POP profile.

At 330, the real-time recommendation service POP profile predictor receives answers back from first customers.

At 340, the real-time recommendation service POP profile predictor assigns the POP profiles to the first customers based on the answers.

At 350, the real-time recommendation service POP profile predictor trains a MLM 113 on transaction data and customer data associated with the first customers to predict the POP profiles for second customers that fail to provide any answers back to the POP questions.

At 360, the real-time recommendation service POP profile predictor obtains the POP profiles for the second customers based on second transaction data and second customer data provided as input to the MLM 113.

At 370, the real-time recommendation service POP profile predictor provides the POP profiles for the first customers and the second customers to a recommendation engine 123 associated with the transaction sessions for determining recommendations provided to the first customers and the second customers during the transaction sessions.

In an embodiment, at 380, the real-time recommendation service POP profile predictor is processed as an intermediary between the transaction interfaces and the recommendation engine 123 during the transaction sessions.

In an embodiment of 380 and at 381, the real-time recommendation service POP profile predictor processes an API for interaction with the transaction interfaces and the recommendation engine 123 during the transaction sessions.

In an embodiment, at 390, the real-time recommendation service POP profile predictor is provided and processed as a SaaS to the transaction interfaces and the recommendation engine 123.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
integrating a Purpose of Purchase (POP) question into a transaction session of a customer;
assigning a POP profile to the customer of the transaction session when an answer is provided by the customer to the POP question during the transaction session;
predicting the POP profile for the customer when the customer fails to provide the answer to the POP question based on transaction data for the transaction session and customer data for the customer; and
providing the POP profile for the customer to a recommendation service for use as a factor in providing the customer with a recommendation during the transaction session.

2. The method of claim 1, wherein integrating further includes receiving a request initiated through an interface of the transaction session for the POP question.

3. The method of claim 2, wherein receiving further includes receiving the request from the interface via an Application Programming Interface (API) initiated within a workflow of the interface during the transaction session.

4. The method of claim 3, wherein receiving further includes receiving the request via a device associated with an online transaction of the customer with an e-commerce service.

5. The method of claim 3, wherein receiving further includes receive the request via a transaction terminal associated with an in-store transaction of the customer with a retail store.

6. The method of claim 1, wherein providing assigning further includes training a machine-learning model based on the answer, the transaction data, and the customer data to subsequently predict a new POP profile for a new customer associated with a different transaction session.

7. The method of claim 1, wherein predicting further includes obtaining the customer data as a transaction history associated with the customer and loyalty data associated with the customer.

8. The method of claim 7, wherein obtaining further includes providing the transaction data, the transaction history, and the loyalty data for the transaction session as input to a trained machine-learning module and receiving the POP profile as output from the trained machine-learning module.

9. The method of claim 8, wherein providing further includes receiving a result associated with the recommendation made during the transaction session and re-training the trained machine-learning model based on the result.

10. The method of claim 1 further comprising, processing the method as an intermediary interface between a transaction interface associated with the transaction session and the recommendation service.

11. The method of claim 10, wherein processing further includes using an Application Programming Interface (API) provided to the transaction interface and the recommendation service for processing the intermediary interface.

12. The method of claim 1 further comprising, processing the method as a Software-as-a-Service (SaaS) to a retailer's transaction system and the recommendation service.

13. A method, comprising:
receiving requests for Purpose of Purchase (POP) profiles through transaction interfaces associated with customers engaged in transaction sessions via the transaction interfaces;
providing POP questions back to the customers for presentation within the transaction interfaces to the customers;
receiving answers back to the POP questions from first customers;
assigning the POP profiles to the first customers based on the answers;
training a machine-learning model on transaction data and customer data associated with the first customers to predict the POP profiles for second customers that fail to provide any of the answers back to the POP questions;
obtaining the POP profiles for the second customers based on second transaction data and second customer data provided as input to the machine-learning model; and
providing the POP profiles for the first customers and the second customers to a recommendation engine associated with the transaction sessions for determining recommendations provided to the first customers and the second customers during the transaction sessions.

14. The method of claim 13, wherein providing the POP questions further includes providing available answers as multiple-choice selections in each of the POP questions.

15. The method of claim 14, wherein providing the available answers further includes mapping each of or a unique combination of the multiple-choice selections to a particular POP profile.

16. The method of claim 13 further comprising, processing the method as an intermediary between the transaction interfaces and the recommendation engine during the transaction sessions.

17. The method of claim 16 further comprising, processing an Application Programming Interface (API) for interaction with the transaction interfaces and the recommendation engine during the transaction sessions.

18. The method of claim 13 further comprising, processing the method as a Software-as-a-Service (SaaS) to the transaction interfaces and the recommendation engine.

19. A system, comprising:
a transaction server comprising an e-commerce server or a retail store server;
a recommendation engine server; and
a cloud or a server;
wherein the transaction server is configured to request Purpose of Purchase (POP) questions from the cloud or the server, present the POP questions within workflows of a transaction interface during transaction sessions with customers, and present recommendations received from the recommendation engine server within the workflows of the transaction interface during the transaction sessions to the customers;
wherein the recommendation engine is configured to receive POP profiles for the customers during the transaction sessions from the cloud or server, use the POP profiles as factors in determining the recommendations, and provide the recommendations to the transaction interface of the transaction server;
wherein the cloud or the server is configured to: provide the POP questions to the transaction interface of the transaction server, assign the POP profiles based on any answers received from the transaction interface of the transaction server, predict the POP profiles when no answers are received from the transaction interface of the transaction server, and provide the POP profiles to the recommendation engine server during the transaction sessions.

20. The system of claim 19, wherein the cloud or the server is configured to train a machine-learning model to predict the POP profiles based on the answers received from some of the customers during some of the transaction sessions using transaction data and customer data associated with the transaction sessions and the customers.
